(19) United States
(12) Patent Application Publication
(10) Pub. No.: US 2022/0197042 A1
(43) Pub. Date: Jun. 23, 2022

(54) IMAGE GENERATING DEVICE FOR A SCANNING PROJECTION METHOD WITH BESSEL-LIKE BEAMS

(71) Applicant: OQMENTED GMBH, Itzehoe (DE)

(72) Inventors: Ulrich HOFMANN, Itzehoe (DE); Joachim JANES, Itzehoe (DE)

(21) Appl. No.: 17/610,825

(22) PCT Filed: May 13, 2020
(86) PCT No.: PCT/DE2020/100407

§ 371 Date: Nov. 12, 2021

(30) Foreign Application Priority Data
May 15, 2019 (DE) 10 2019 207 073.6

(51) Int. Cl. G02B 27/09; G02B 26/08; G02B 26/10; G02B 5/00; H04N 9/31

(52) U.S. Cl. CPC G02B 27/0927; G02B 26/0833; H04N 9/3135; G02B 5/001; G02B 26/101

(57) ABSTRACT

The invention relates to an image generating device having a radiation source for one or more output beams having Gaussian radiation characteristic, in particular a laser beam source, having a device for generating Bessel-like beams from one or more output beams, having a controllably drivable MEMS scanner, wherein the Bessel-like beams are directed onto the MEMS scanner and are deliberately deflected by the MEMS scanner to generate an image, and having at least one display body at least partially transmissive to the Bessel-like beams, onto which the Bessel-like beams are guided by the MEMS scanner.

The invention is in the field of optics and image generation. It is particularly advantageously usable, for example, for image projectors.

Scanning image projection methods are known in principle. In such methods, a beam, for example a laser beam, is typically deflected deliberately by means of a controllable mirror and the beam intensity is modulated during the deflection. A recognizable image results on a projection surface in this way.

The resolution of known projection methods is not only limited by imaging optical unit and the quality of the control of the mirror or other elements deflecting the beam, but also by the quality, in particular the dimensions, of the image-generating beams themselves.

Against the background of the prior art, the present invention is based on the object of providing a scanning projection method and an image generating device which permit images to be generated having the highest possible resolution.

The object is achieved by the features of the invention according to claim 1. Claims 2 to 10 present possible implementations of the device.

Accordingly, the invention relates to an image generating device having a radiation source for one or more output beams having Gaussian radiation characteristic, in particular a laser beam source, having a device for generating Bessel-like beams from one or more output beams, having a controllably drivable MEMS scanner, wherein the Bessel-like beams are oriented on the MEMS scanner and are deliberately deflected by the MEMS scanner to generate an image, and having a display body at least partially transmissive to the Bessel-like beams, onto which the Bessel-like beams are deflected by the MEMS scanner.

The invention is based on the concept that the resolution of scanning projection methods is also limited, inter alia, by the beam profile of the Gaussian beams typically used, for example in the form of laser beams. The focusing and beamforming of Gaussian beams to form small beam diameters are subject to physical limits in principle.

It results from the solutions of the Helmholtz equation, which describes fundamental electromagnetic radiation, that smaller beam diameters are possible by way of so-called Bessel beams, named after the Bessel functions, which describe possible solutions of the Helmholtz equation, than using the typical Gaussian beams. Ideal Bessel beams which are described by the mentioned Bessel functions cannot be generated in practice any more than ideal Gaussian beams can. Therefore, the description of the present invention hereinafter refers to Bessel-like beams, which have properties that are close to the properties of the ideal Bessel radiation. Practical possibilities for generating Bessel-like beams are known and originate from the use of Gaussian beams and their forming into Bessel-like beams. The properties of the Bessel beams and Bessel-like beams will be described in more detail in conjunction with the description of the figures.

According to the invention, an image can therefore be made visible on a display body with greater resolution using a MEMS scanner. The pixel resolution can be, for example, in the order of magnitude of 1000×1000 pixels per square centimeter.

One advantageous embodiment of the invention can be that a projection device is provided which projects the image from the display body by means of a projection optical unit on a projection surface. The display body can first act like a type of focusing screen, on which the image generated by the Bessel-like beams is visible. This image can be projected by the projection device, for example, on a larger surface, to make the image better and/or more comfortably visible for users.

One possible embodiment of the invention can provide that the device for generating Bessel-like beams has at least one axicon. An axicon is understood as an optical component which can be provided in reflective or refractive embodiment, which is made rotationally symmetrical in most cases, and which generates ring-shaped beam profiles in far field approximation. It is optimal for this purpose that a laser beam, and thus a Gaussian beam, is radiated in collinear to the optical axis of the axicon. The ring-shaped beam profile is concentrated, for example, focused or collimated, by the further beam guiding on the smallest possible area. An imaging optical unit or a further axicon can be used for this purpose.

It can be provided here that at least one axicon is designed as a mirror or as a light-refractive element, in particular as a lens.

In such a case, the starting beam passes through both axicons in succession, wherein a combination made of two axicons can additionally be combined with an imaging optical unit.

Specifically, it can be provided that the device for generating Bessel-like beams has at least two axicons aligned coaxially to one another.

In another embodiment it can also be provided, for example, that the device for generating Bessel-like beams has an aperture having a ring gap, onto which the starting beam or beams are oriented, wherein in particular at least one converging lens is provided behind the ring gap seen from the radiation source. A Bessel-like beam having an extremely narrow intensity distribution may also be produced by such a device.

In principle, the MEMS scanner used can have one or more drivable pivotable or rotatable mirrors which are pivotable around different axes so that the beam is deflectable in two dimensions to generate a two-dimensional image. It can be reasonable here that the axes of the mirror or mirrors are perpendicular to one another. It is also possible in principle for some applications to provide a mirror, in particular a MEMS mirror, which is only rotatable or pivotable around a single axis.

It is particularly advantageous here if, in the case of multiple provided pivot axes, these axes intersect. This is because if one beam passes through two pivotable mirrors in succession, both the reflection losses and also errors in the deflection thus add up. Partially this is also because the beam already deflected by the first mirror travels onto the second mirror, so that inhomogeneities on the mirror surface can result in errors.

It can therefore advantageously be provided according to the invention that the MEMS scanner is designed as a 2D MEMS scanner having a mirror rotatable or pivotable around multiple axes. In fundamentally known 2D MEMS scanners, a single mirror is rotated by suitable drives around two different axes to generate a two-dimensional image. Errors in the image generation can be minimized by using such a 2D MEMS scanner.

A further advantageous embodiment of the invention can provide that a capsule wall of the MEMS scanner is designed as a display body, wherein the capsule wall for the image generation in particular has a planar section or a section in the form of a spherical cap, the sphere center point of which coincides with the point in which two pivot axes of a MEMS mirror intersect. In many cases, the described MEMS scanners are encapsulated and have a capsule wall at least partially transparent to the radiation used. For example, the scanner can be protected from environmental influences by the capsule, and the space in which the drivable mirror moves can also be evacuated, for example, to minimize air friction losses and optimize the deflection of the mirror.

A section of the capsule wall can be used to serve as a type of focusing screen in order to generate the scanning projection on this section in such a way that it is recognizable from outside the capsule. A typical design of the capsule wall as focusing screen, for example, by roughening the capsule wall on the inside or outside, will often not be sufficient here, since the possible resolution achievable by the use of the Bessel-like beams can exceed the resolution of such a focusing screen. The material of the capsule wall is therefore advantageously to have a structure which enables a forward scattering of the incident light with high position resolution. For this purpose, the capsule wall can be admixed or coated, for example, with a phosphorescent substance, for example, also coated with a phosphorescent film. However, any other type of the composition of such a capsule wall which enables a high-resolution forward scattering is also conceivable.

The shape of the capsule wall or specifically the section of the capsule wall on which the image can be generated can correspond, for example, to a spherical cap, the sphere center point of which coincides with the point at which two pivot axes of a MEMS mirror intersect. In such a case, an image is generated which is simple to calculate and has a position resolution that is uniform over the image extension. It is also conceivable to use a planar section of the capsule wall for the image projection. Distortions of the generated image are to be taken into consideration mathematically in simple form if the underlying geometry is known during the image generation, i.e., when setting the respective deflection angle of the MEMS scanner for individual pixels.

If a single deflection mirror/MEMS mirror is used, which is only pivotable around a single axis, a cylindrical or semicylindrical capsule housing can also be provided or a cylindrical section of the capsule housing. The cylinder axis can then advantageously be aligned in parallel to the pivot axis.

In principle, it is also to be noted that the image can be generated both on the inside of the capsule wall and also on the outside or also in a layer located in between.

If a phosphorescent substance is used, the wavelength of the Bessel-like beams is thus obviously to be matched to the material in such a way that phosphorescence is generated.

Since Bessel-like beams are used in the image generating device according to the invention, which have a ring-shaped intensity distribution at least sectionally in sections of the beam profile, such a ring-shaped intensity distribution can also be present upon the reflection on the MEMS mirror or mirrors, since the beams are only compressed to the optimized beam diameter after the MEMS scanner. This means that in many cases the central region of the MEMS mirror or mirrors is not needed for a reflection. Such a region can therefore be left out for mass reduction of the MEMS mirror or the MEMS mirrors. Such a recess can be formed circular or also elliptical, for example, if the Bessel-like beams are incident at a flat angle on the MEMS mirror.

### Bessel Beams

Bessel beams were theoretically described in 1987 and experimentally generated shortly thereafter. Bessel beams are understood as one of the solutions of the Helmholtz equation, namely an electromagnetic field, the amplitude of which is described by a Bessel function of the first type. In normal usage, the rotationally-symmetrical special case m=0 is referred to as a Bessel beam or more precisely as a Bessel-like beam. Generating Bessel beams requires an infinitely extended flat wave, which is not to be produced in practice. In the further text, the expression Bessel beams is sometimes used, wherein Bessel-like beams are meant.

To generate Bessel beams, laser beams (gauss beams or Gaussian beams) are formed using special lenses. In contrast to laser beams having a Gaussian characteristic, no diffraction effects arise in Bessel beams, and the beam geometry does not change during the propagation. The usable properties of Bessel beams are that their central maximum has a high beam density and that this central maximum has a small radial dimension.

To produce Bessel-like beams, Gaussian beams are superimposed, for example, with the aid of axicons. Axicons are conical optical components which can be applied in reflective or in lenticular, refractive embodiment. Axicons are produced in both concave and also convex form. They can consist of any suitable optical material (suitable with regard to wavelength, laser power, inter alia). Both in reflective and also in lenticular embodiment, axicons generate ring-shaped beam profiles in the far field approximation as soon a laser beam is radiated in, for example, collinear or approximately collinear to the optical axis of an axicon. The ring width of the ring-shaped beam results as approximately half of the diameter of the Gaussian input beam. If either further axicons or lenses are used on the optical axis, beam profiles having different geometry may thus be produced.

For the application of axicons in the device described here it is essential that the type of the Bessel beams generated is essentially dependent on the axicon angle, which defines the beam geometry.

In the same way as is carried out, for example, for laser beams in optical surgery, two axicons are combined with one another to produce a collimated beam having ring-shaped intensity distribution. The distance of the two axicons then defines the diameter of the ring-shaped intensity distribution. For the generation of Bessel beams or specifically Bessel-like beams, it is then also true that their lateral distribution and their depth are dependent on the input diameter. Combining axicons with various optical lenses, which are used for the definition of the beam geometry (for example as beam expanders) is also a known practice. However, not only axicons are used for generating Bessel beams. An alternative production method is to have a collimated laser beam incident through a ring gap having suitable diameter. The laser beam is diffracted at this ring gap. A lens having a focal length which approximately corresponds to the distance to the ring gap collimates the ring-shaped intensity distribution and thus generates a Bessel-like beam.

### MEMS Scanners

For applications of the present invention here, image generation using 2D MEMS scanners suggests itself. Such scanners are described, for example, in the following documents:
DE 199 41 363 B4: method for producing a microactuator component;
DE 10 2004 060576 B4: optical-electronic laser scanning method and arrangement for its operation;
DE 10 2006 058536 B3: micromirror actuator having encapsulation possibility and method for its production;
EP 2102 096 B1: hermetic wafer level package for optical MEMS usable in a mobile manner;
DE 10 2008 012384 A1: geometrical reflection suppression on encapsulated micromirrors;
EP 2514 211 B1: method and device for single-axis or multiaxis beam deflection;
EP 2828 701 B1: micromechanical mirror actuator for the deflection of high laser power;
DE 10 2013 206396 A1: resonant micromirror actuator having large oscillation amplitude

The 2D scanners are not subject to any restrictions with respect to their embodiment and their type of drive.

MEMS scanners can be driven, for example, electrostatically, piezoelectrically, magnetically, mechanically, or in another way. It only has to be ensured that a sufficiently accurate measurement method is provided for the angle position in both directions. One advantageous aspect in the selection of a 2D scanners is that both torsion axes lie in one plane and that there is therefore a common pivot point for the deflections in two independent directions.

A structure which uses two 1D scanners and thus also covers the desired spatial angle range is also possible, but is less advantageous for geometrical reasons in some applications.

The scanning frequencies on both axes are dependent on the application. 2D MEMS scanners which are presently produced reach oscillation frequencies, for example, of several hundred hertz on one axis up to several tens of kilohertz on the other axis. However, 2D MEMS scanners having identical or similar scanning frequencies in both oscillation directions can also be used. The frequencies of the two axes define the maximum repetition rate at which a volume is illuminated.

The condition for the image generation is the precise knowledge of the angle position of the scanners in both axes at each point in time during the image generation. For example, capacitive readout methods, optical position-sensitive detectors, strain gauges, piezoelectric methods, and further methods are available for the measurement of the angle position.

### Glass Encapsulation/Vacuum Encapsulation

Various designs and methods are available for the vacuum-tight covering of MEMS mirror units. One exemplary method for producing a MEMS mirror arrangement, in which a transparent cover is closed hermetically sealed with a carrier substrate, on which a mirror oscillating around at least one axis is suspended, has the following steps:
providing a silicon wafer,
structuring the silicon wafer in such a way that a plurality of depressions are produced, which each correspond to the footprint of the cover,
bonding a cover wafer made of glasslike material onto the structured silicon wafer, wherein an inert gas is enclosed at a predetermined pressure in the cavities formed by the depressions on the cover wafer,
tempering the composite made of silicon wafer and cover wafer in such a way that a plurality of domes is formed by the expansion of the enclosed inert gas,
after cooling the composite made of silicon wafer and cover wafer, partially or completely removing the silicon wafer,
arranging a mirror wafer, which comprises a plurality of mirrors suspended on the carrier substrate, in relation to the cover wafer in such a way that the mirror centers are each in the center point of the domes,
joining and hermetically sealed closing of the cover wafer with the mirror wafer,
isolating the composite made of cover wafer and mirror wafer into individually capped MEMS mirror arrangements.

In another method, instead of the silicon wafer, a tool is used which consists of material preventing a hot glasslike material from sticking or is coated using a material preventing a hot glasslike material from sticking. This tool is or will be provided with passage openings. A cover wafer made of glasslike material is laid on the tool provided with passage openings, and a negative pressure is applied to the side facing away from the cover wafer. The tempering of the composite made of tool and cover wafer takes place in atmospheric conditions in such a way that a plurality of domes is formed by suctioning the cover wafer into the passage openings due to the negative pressure. After cooling of the composite made of tool and cover wafer, the tool is removed. The further steps correspond to those of the method specified above.

### Display Screen, Focusing Screen

It is possible to generate a real image using the proposed device, which is subsequently projected, for example, using a corresponding projection optical unit on a screen. The simplest possibility for generating such an image is to use a focusing screen, as was typical in the past in photography. The focusing screen is produced either on the inside or the outside of the glass capsule of the MEMS scanners, to generate a real image there. However, against the background that the real image is to be generated with the aid of scanning Bessel beams, thus using beams of particularly high lateral resolution, the grain size or the graininess of typical focusing screens does not fully utilize the available resolution. The pixel resolution possible using Bessel beams would be reduced upon the use of focusing screens.

Depending on the specific application of the device, it is also possible to apply a phosphorescent layer on one of the surfaces of the glass body of the vacuum capsule. The phosphorescent layer is typically irradiated using “blue” laser light. A known conversion process in the phosphorescent layer has the result that light having greater wavelengths is emitted therefrom.

For some years, a projection surface has existed which is also referred to as a “transparent fluorescent film” or also “super imaging film” (“transparent fluorescent film”). This film essentially consists of nanoparticles which are transparent in the visible wavelength range due to the small diameter of the particles. If this film is illuminated using laser light, for example, of the wavelength of 405 nm, the film then emits in all directions and at greater wavelengths, for example, blue or red, incoherent light. A Bessel beam which is reflected from the MEMS scanners oscillating in two directions and passes over a surface section of the vacuum capsule projects an image on this small display screen in this way.

Generating an image by scanning a laser beam or a Bessel beam, which is deflected, for example, by a 2D MEMS scanner, and in which the image consists, for example, of 2000×1000 pixels, requires a precise detection of the instantaneous angle position of the MEMS mirror in the two scanning directions.

The detection of the angle position can be carried out by various methods. These include, inter alia, capacitive measurements of conductive surfaces opposite to one another, optical measurements, piezoelectric measurements, or measurements using strain gauges.

The power of the laser is set in dependence on the instantaneous angle position of the MEMS mirror, so that illuminated pixels become visible at the desired positions on a display screen. To achieve this, the laser power is controlled as a function of the angle positions in both pivot directions of the mirror. A controller or regulator is provided for this purpose, which connects the position of the 2D MEMS scanners to the laser power in order to define the pixel intensity with high position resolution.

The fact can be utilized in the image generating device according to the invention that MEMS scanners are equipped with a vacuum capsule for many applications. The glass surfaces of the vacuum capsule can be utilized to generate a real image thereon.

The high pixel resolution is achieved in that a Bessel beam is generated using known methods, which is reflected from the MEMS scanners in its two directions in dependence on time and illuminates a part of the glass body of the vacuum capsule as a display body.

To generate a real image on a surface of the display body, it is advantageous to design the optical properties of this surface. Surface properties of vacuum capsules of the MEMS scanners can be changed in such a way that a real image can be generated using the transparent material, e.g., glass, sapphire, or quartz. Various existing possibilities are open for this purpose.

Firstly, it is to be emphasized that the surface changes are only to be carried out in the section of the vacuum capsule on which the real image is to result. The region of the vacuum capsule through which the laser beams pass before the reflection by the MEMS mirror are to remain free of changes and as transparent as possible. The surface changes or additions which are claimed here comprise, for example, the formation of a focusing screen, the application of phosphorescent materials, and the application of a transparent fluorescent film.

In fact, a real image may also be generated on a fully transparent surface, so that the simple glass surface of the vacuum capsule is sufficient as a display screen in some cases. However, a scanned, real image arises on both surfaces of the glass body with this design, and these double images can be detrimental for the application. In any case, the image resolution is worsened in this way. The simplest possibility having a preparation of the surface is to treat it so that a focusing screen results therefrom. It can be selected here which of the two surfaces of the glass body is embodied as a focusing screen. In this way, it is possible in principle to generate a real image. The resolution with a focusing screen, as was typical in the past in photography, for example, using system cameras, is suboptimal, however. Under the condition that a suitable material for equipping a surface of the vacuum capsule of the MEMS component is found, one of the most promising applications of the invention is to project the image arising on the surface using a suitable projection optical unit onto a large display screen.

Various methods are available for generating Bessel beams. The use of reflective or lens-like axicons or combinations of these axicons is a known and employed procedure. Alternatively, Bessel beams can also be produced in that a laser beam passes through a ring gap and that a diffraction pattern arising after the gap is focused using a suitable lens so that Bessel beams result. However, the invention is independent of the generation method of the Bessel beams.

The application of the invention in the foreground is to generate a real image on one of the surfaces of the vacuum capsule of a 2D MEMS scanner, which is subsequently projected using a projection optical unit on a display screen.

It is important to emphasize that the invention is not restricted to 2D MEMS scanners. Applications for which only a 1D MEMS scanner is required are also comprised.

Typical projection optical units which would project a small real image in the order of magnitude of several square centimeters at a distance of several meters using projection areas of several square meters were used in the past in slide projectors and presently in “video projectors”. They consist of a combination of suitable lenses, the optical properties of which are matched with the stated task. With such a structure, the invention represents an alternative and a replacement for present “video projectors”, in which the image generation is carried out, for example, using DLPs and a projection optical unit.

In the following, the invention is shown on the basis of exemplary embodiments in figures of a drawing and explained hereinafter. In the figures

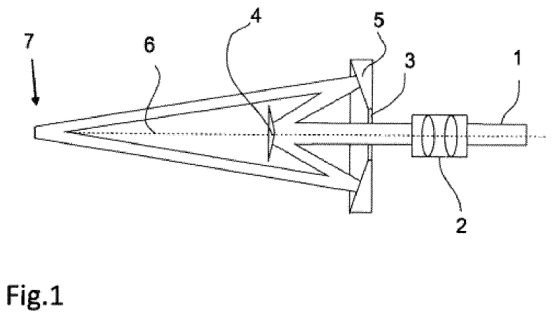

FIG. 1 shows an optical structure for generating Bessel-like beams,

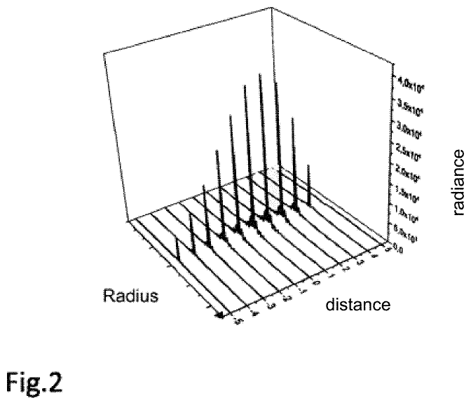

FIG. 2 shows a calculated distribution of the beam density of Bessel beams,

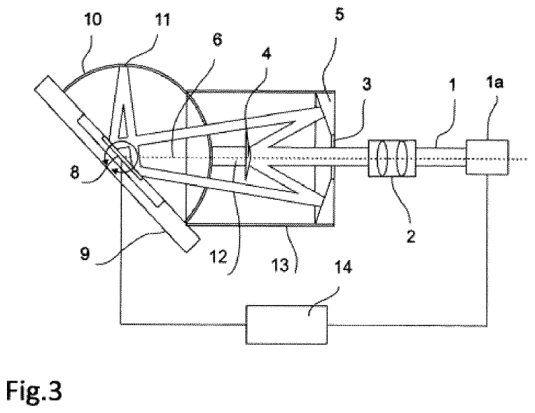

FIG. 3 shows a sectional illustration of a device for generating a real image by means of Bessel-like beams on a spherical glass dome,

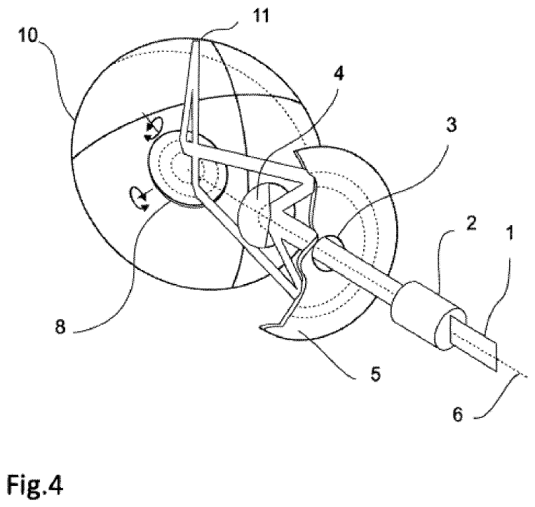

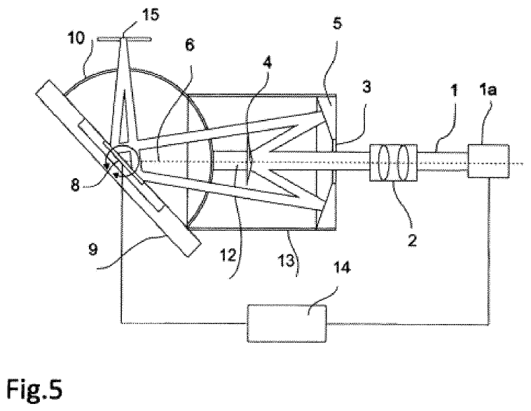

FIG. 4 shows a perspective illustration of a device for generating a real image corresponding to FIG. 3,

FIG. 5 shows a sectional illustration of a device for generating a real image by means of scanned Bessel-like beams on a display screen outside the capsule of a MEMS mirror,

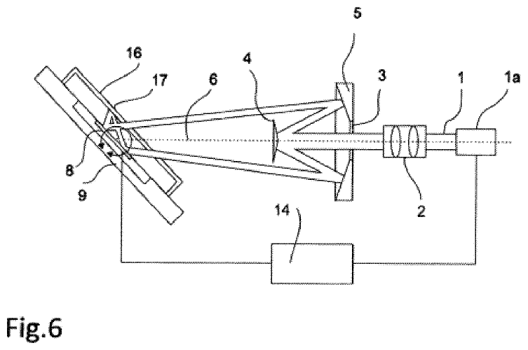

FIG. 6 shows a sectional illustration of a device for generating a real image on the capsule wall of a planar vacuum capsule of a MEMS component,

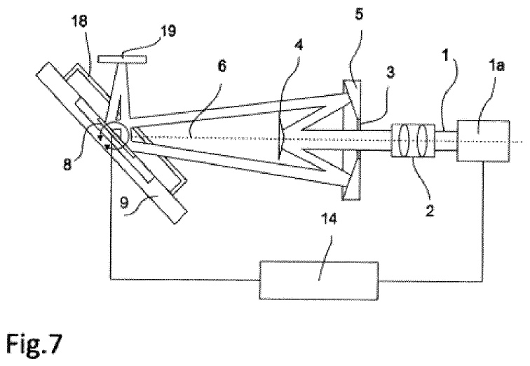

FIG. 7 shows a sectional illustration of a device for generating a real image on a display screen outside a planar vacuum capsule of a MEMS component,

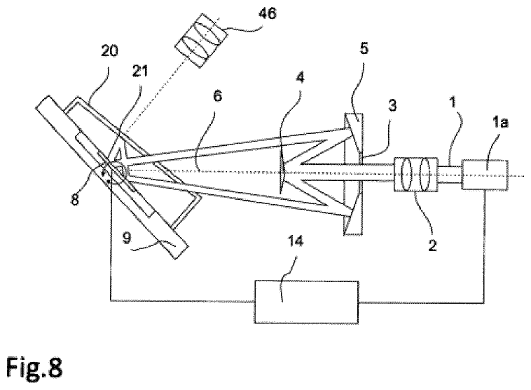

FIG. 8 shows a sectional illustration of a device for generating a real image on a planar capsule wall inclined in relation to the angle of the MEMS component,

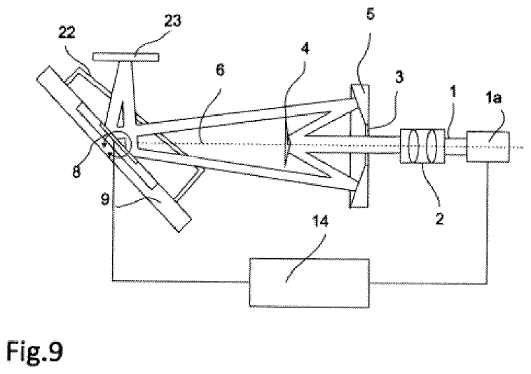

FIG. 9 shows an illustration similar to FIG. 8, wherein the image is generated on a display screen beyond the inclined capsule wall,

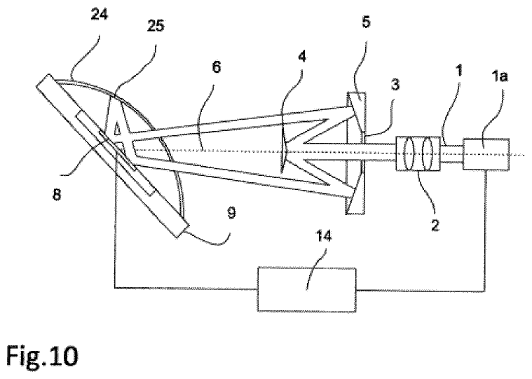

FIG. 10 shows a sectional illustration of a device for generating a real image on a spherically shaped capsule wall of a MEMS element, the center point of which is shifted in relation to the pivot point of the MEMS mirror,

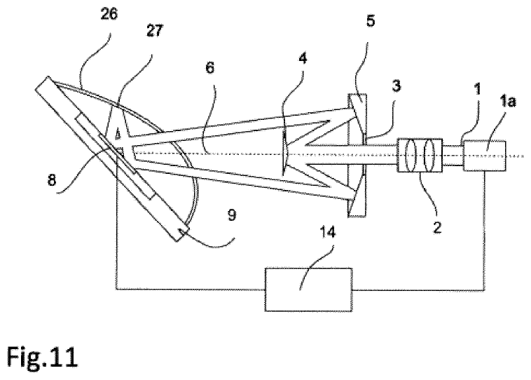

FIG. 11 shows a sectional illustration of a device for generating a real image on a capsule wall having irregular surface shape,

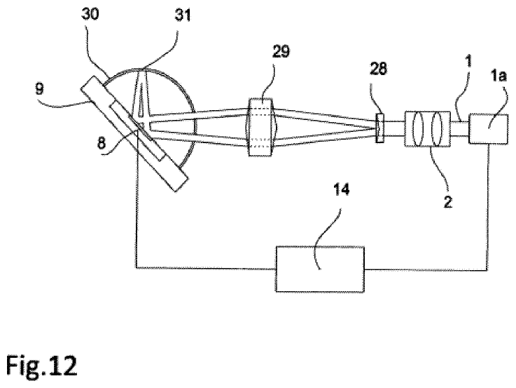

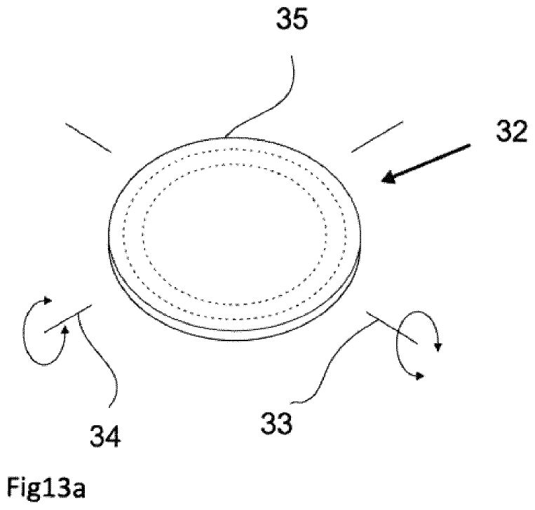

FIG. 12 shows a sectional illustration of a device for image generation by means of scanned Bessel-like beams, wherein the generation of the Bessel-like beams takes place by means of glass body axicons, and

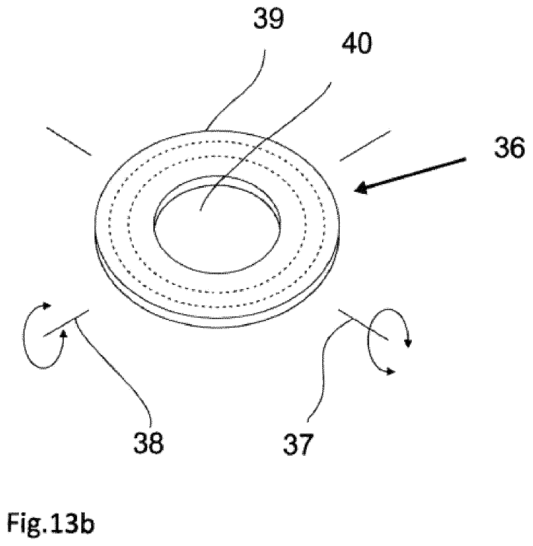

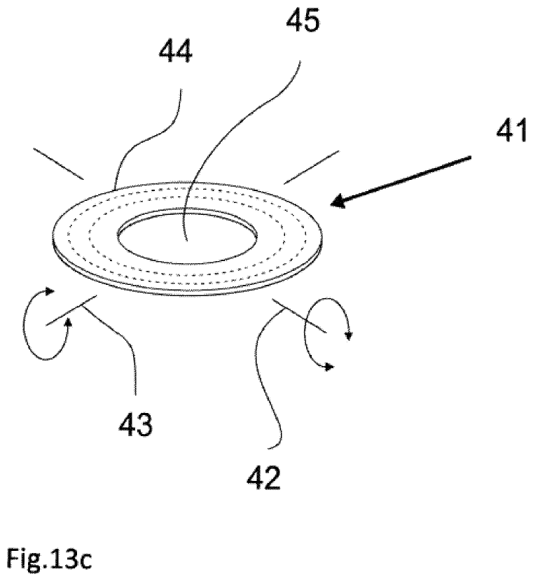

FIGS. 13a-c show possible embodiments of mirrors of a MEMS scanner having recesses.

To produce Bessel beams, reflective axicons are used in the first embodiment, which, as shown in FIG. 1, are constructed so that they enable the superposition of Gaussian beams. A Gaussian beam 1 passes through a beamforming optical unit 2, using which primarily its diameter and its beam divergence are set (the beamforming optical unit is only symbolically illustrated in FIG. 1). After passing through the opening 3 in the component 5, the beam 1 is incident on the conically shaped mirror 4, which is referred to as an “axicon”. In mathematical terms, the conically shaped mirror is a cone. The optical function of the conically shaped mirror is to reflect the Gaussian beam 1 so that a ring-shaped beam cross section arises after the reflection. In these terms, it is advantageous that the Gaussian beam extends on the optical axis (cone axis) of the axicon.

A further reflective axicon 5 is arranged in the beam path in such a way that the ring-shaped intensity distribution of the beam 1 after the reflection at the axicon 4 is completely reflected from the conical surface of the axicon 5. One essential condition for the functionality of the arrangement is that the two optical axes 6 of the two axicons 4 and 5 are ideally collinear. The axicon 5 reflects the ring-shaped intensity distribution in the direction of the optical axis 6. The geometry of the arrangement has to provide that the axicon 4 is not in the beam path of the ring-shaped intensity distribution collimated by the axicon 5. The ring-shaped intensity distribution is transferred into the volume 7 at a distance which is dependent on the reflection angles of the axicons 4 and 5.

The summed structural length of the elements 2, 3, 4, 5, 6, and 7 is approximately 15-20 mm in the simulation shown in FIG. 1, and the input beam diameter of the laser beam 1 is 1 mm here, for example.

The calculated intensity distribution which results from the superposition of the ring-shaped light distribution in the volume 7 is shown in FIG. 2. The calculation is based on ideal conditions in such a way that, for example, simulation was performed with exactly one wavelength without bandwidth. Furthermore, the input beam has an ideal phase and planar wavefronts. In the illustration, the simulated beam density is shown as a function of the lateral extension of the axial position in the direction of the axis 6 within the volume 7.

FIG. 2 shows the theoretical beam density distribution of the Bessel beams which is achieved using the structure shown in FIG. 1. The essential property of the Bessel beams for the above-described stated object is the lateral dimension thereof found in the simulation of several micrometers for the central maximum and several secondary maxima having intensities of less than 10% of the intensity of the central maximum. In addition, it can be seen in FIG. 2 that the central maximum only has a relatively minor variation of the intensity along the optical axis.

FIG. 3 shows a sectional illustration of the structure according to the invention for generating Bessel beams and the projection thereof on a spherical surface. A laser 1a as a radiation source having a (Gaussian) laser beam 1 is set with respect to its diameter and its divergence using a beamforming optical unit 2. The laser unit 1a can also consist of a combination of lasers which meet the required conditions for generating a real image. After passing through the opening 3, the laser beam is incident on the first axicon 4. The beams reflected from the axicon 4 form a ring-shaped intensity distribution and are then incident on the second axicon 5. The optical axes of the axicons 4 and 5 are collinear. The center of the laser beam 1 is also ideally, but not necessarily, on the optical axis 6. Certain axial deviations of both the laser and also the axicon are possible and can be corrected or calculated out later during the image generation.

The pivot point of the MEMS scanner 8 is also advantageously on the optical axis 6. The MEMS scanner is part of the MEMS component 9, which contains the mechanical and electrical functionality of the scanner. The installation angle of the MEMS component 9 relative to the optical axis 6 is defined, on the one hand, by the application and, on the other hand, by the optical scanning angle which the scanner mirror 8 is to enable. The MEMS component is provided with an optically transparent vacuum capsule 10, which is embodied here in spherical form. The vacuum capsule 10 increases the Q value of the torsion oscillations of the mirror and thus the angle amplitudes of the oscillations. It consists of optically transparent material which also has to meet the boundary conditions of a process control for MEMS components (for example: matching thermal coefficient of expansion).

The ring-shaped intensity distribution which is reflected at the axicon 5 passes through the spherically embodied material of the vacuum capsule 10. Notwithstanding the precise geometrical shape of the capsule 10, it is also true for the embodiments shown hereinafter that the material thickness/glass thickness is advantageously to be essentially constant. For the case in which the glass thickness is variable, lens effects can induce a significant distortion of the generated images. Material thicknesses/glass thicknesses of MEMS vacuum capsules are approximately in the range of 50 μm to 500 μm, wherein usually the lowest possible glass thickness is desired. In the embodiment shown here, the center of the spherical vacuum capsule 10 lies on the optical axis 6. The axicon angle of the axicon 5 is set in such a way that the ring-shaped intensity distribution is collimated toward the MEMS scanner 8 and then a superposition of the intensity on the vacuum capsule 10 takes place in the section 11. Bessel beams thus arise in the section 11, the profile of which is simulated and shown in FIG. 2. If the MEMS scanner 8 executes a torsion oscillation in one or in two of the possible directions, the section 11 then moves corresponding to the reflection conditions at a constant distance around the pivot point of the MEMS scanner 8. This has the result that the intensity distributions shown in FIG. 2 also move around the pivot point of the scanner 8.

To ensure that the optical axes of the axicons 4 and 5 continuously correspond to the pivot point of the MEMS scanner, the axicons 4 and 5 are connected using the holding elements 12 and 13 to the MEMS component.

A transparent fluorescent film is preferably applied to the sphere surface of the capsule 10. The film can be applied to both the inner surface and also the outer surface of the capsule without impairing the function. The film is illuminated by the scanned Bessel beams. The intensity distribution shown in FIG. 2 generates fluorescent light pixel by pixel. If the Bessel beams are scanned in dependence on time in two directions using the 2D MEMS scanner 8, a plurality of pixels arises. If the laser power is controlled accordingly, a real image arises in the film on the sphere surface due to pixels of different brightness.

The capsule 10 consists of suitable glass material. For example, borofloat glass is used for processing reasons for the production of the vacuum capsules having a spherical glass dome.

Notwithstanding the thickness of the glass material, two surfaces are present. Both surfaces of the dome-shaped capsule section, the outer surface and the inner surface, can be selected as the projection surface. One of the selected surfaces is then, for example, coated using the phosphorescent material or covered using the fluorescent film or treated using other means. A projection screen thus results on one of the selected surfaces, on which the pixels generated by the scanned Bessel beams generate a real image.

Due to the fact that both the axicons 4 and 5 and also the pivot point of the scanner mirror 8 are to lie as exactly as possible on one axis, it is advantageous to align the corresponding components in relation to one another and permanently install them. It is to be taken into consideration here that the connecting elements do not negatively affect the beam path of the laser 1a. For this reason, the axicon 4 is installed on a mount 12, which is fastened on the dome of the capsule 10.

The alignment of these components in relation to one another and the alignment of the axicon axis on the pivot point of the scanner mirror 8 take place using the known in situ alignment methods. The axicon 5 is installed, for example, in a cylindrical mount 13. It is important that the axicon axis and the cylinder axis are also aligned collinear with one another here. The mount 13 together with the axicon 5 are then also aligned using the known in situ alignment methods relative to the axis on which the pivot point of the scanner mirror 8 and the axis of symmetry of the axicon 4 lie and fastened on the surface of the glass dome of the capsule 10.

The use of axicons and the ring-shaped intensity distribution of the laser light resulting therefrom enable an advantageous embodiment of the scanner mirror 8. Since the ring-shaped intensity distribution is also to be found on the mirror surface of the scanner mirror 8 in the exemplary embodiment described here, this mirror can also be produced in the form of an elliptical ring having a central recess. This also comprises the shape of a circular ring. The ring-shaped intensity distribution of the laser beam 1, which is incident on a scanner mirror 8 at an angle of incidence (for example 45° here), results in an elliptical intensity distribution on the mirror surface. The advantage of a recess in relation to the scanner mirror 8 is that an elliptical ring having defined outer boundary has a lower mass than a scanner mirror 8 which is embodied as a full elliptical disk. The lower mass of the scanner mirror 8 has the result that a smaller torque is required to achieve the same angle amplitudes than in the case of a scanner mirror produced from solid material. Notwithstanding the type of drive of the scanner mirror 8, this means a lower drive force and, for example, lower drive voltages or lower drive currents in accordance with the types of drive (see FIGS. 13a-c in this regard).

To generate a real image with pixel accuracy, it is necessary to determine or detect the angle position of the MEMS scanner 8 in both oscillation directions and to regulate or control the required illuminance of a pixel which is projected precisely in the direction of the corresponding angle position of the MEMS scanner 8. The detection and regulating unit 14 links the angle position of the MEMS scanner 8 to the activation of the laser 1a to control the laser intensity for each pixel to be projected. The detection and regulating unit 14 can also be designed for the control or regulation of a combination of lasers.

The image generated on the glass dome of the capsule 10 has an area of at most several square centimeters (1 cm²-2 cm²) and can have a pixel density of up to 2000 pixels per centimeter in one direction in dependence on the achieved pixel resolution by the Bessel beams within the projection surface. Such a real image can be projected using a typical projection optical unit, for example, on a large display screen at a typical distance of several meters from the MEMS mirror.

FIG. 4 shows the structure, which is already presented as a sectional illustration in FIG. 3, in a perspective illustration. The laser beam 1 and the following ring-shaped intensity distributions are shown as a section in the vertical plane for reasons of illustration. The dashed lines on the axicons 4 and 5 and on the MEMS scanner 8 indicate the regions which are illuminated either by the laser beam 1 or by the following ring-shaped intensity distributions. The MEMS scanner 8 is shown here as a 2D MEMS mirror having the indicated torsion axes.

FIG. 5 shows a sectional illustration which shows essentially the same structure for generating Bessel beams as FIG. 3. Only the axicon angle of the axicon 5 is set in such a way that the overlap region of the ring-shaped intensity distribution 14 is outside the spherical vacuum capsule 10 and thus at a greater distance from the axicon 5 than in FIG. 3. A similar constellation is also achievable, of course, using the adaptation of distances of the axicons 4 and 5 and the axicon angle of axicon 4. Bessel beams also form here within the overlap volume of the ring-shaped intensity distribution, as are simulated and shown in FIG. 2. The Bessel beams are then incident on a display screen 15, which is used to make the intensity distribution visible, as indicated in FIG. 2. In this structure as well, the torsion oscillations of the MEMS scanner have the effect that the Bessel beams pass over the display screen 15 in accordance with the reflection conditions. In this exemplary embodiment, in contrast to the embodiment shown in FIG. 3, the display screen is coated using the phosphorescent material or provided with the fluorescent film. A real image resulting in this way can in turn be projected using a typical projection optical unit, for example, on a large display screen at a typical distance of, for example, several meters.

The geometrical form of the vacuum capsule is not restricted to spherical embodiments.

FIG. 6 shows an embodiment of the vacuum capsule having a planar glass plate 16, which is arranged in parallel to the MEMS component 9. The axicon angles of the axicons 4 and 5 and their distances are set in such a way that the superposition of the ring-shaped intensity distribution and thus the forming of Bessel-like beams takes place in the region 17. In this way, the intensity distribution of the Bessel beams shown in FIG. 2 results on the planar glass cover 16. When the MEMS scanner executes torsion oscillations, the region 17 of the superimposed intensity distribution is shifted accordingly and thus passes over the planar glass cover. In contrast to the embodiment in FIG. 3, the distance between the pivot point of the MEMS scanner and the position of the region 17 on the planar glass cover 16 also changes with the scanning angle of the MEMS scanner.

It can be seen in FIG. 2 that the intensity distribution of the Bessel beam occurs in a specific range of the distance (for example from the axicons) (in the simulation of FIG. 2, this distance is approximately 10 mm). The distance range is primarily dependent on the diameter of the laser beam 1 and the intersection angle of the ring-shaped intensity distribution in 17. The generation of a real image on the planar glass cover 16 then takes place in the same manner as in the exemplary embodiment in FIG. 3. For example, either a phosphorescent layer is applied to the outside or to the inside of the glass cover 16, or one of the two sides is provided with a fluorescent film, or another method is applied for producing a real image.

The fastening and alignment of the axicons 4 and 5 on a common axis which also extends through the pivot point of the MEMS scanner 8 has to be solved individually for individual MEMS scanner systems.

FIG. 7 shows a sectional illustration which shows essentially the same structure for generating Bessel beams as FIG. 6. Only the axicon angles of the axicons 4 and 5 are set in such a way that the overlap region of the ring-shaped intensity distribution is outside the planar glass cover 18. The adaptation of the distances of the axicons 4 and 5 achieves the same goal. Bessel beams also form here within the overlap volume of the ring-shaped intensity distribution, as are simulated and shown in FIG. 2. The Bessel beams are then incident on a display screen 19, which is used to make the intensity distribution visible. In this structure, the torsion oscillations of the MEMS scanner also cause the intensity distribution of the Bessel beams to pass over the display screen 19 in accordance with the reflection conditions. In this exemplary embodiment, in contrast to the embodiment shown in FIG. 6, the display screen 19 is then coated with a phosphorescent material or provided with the fluorescent film.

Similarly to the exemplary embodiment of FIG. 6, an embodiment is shown in FIG. 8 in which a planar vacuum capsule 20 of the MEMS component is provided, but in contrast to FIG. 6, it encloses an angle greater than 0° with the surface of the component. Such a design of the vacuum capsule is applied to be able to set the direction of reflection spots in laser projection methods (see DE 10 2008 012 384 A1). In the same way as in the exemplary embodiment shown in FIG. 6, an intensity distribution similar to that shown in FIG. 2 results in the region 21.

The generation of a real image on the inclined, planar glass cover 20 then takes place in the same way as in the exemplary embodiment in FIG. 6. For example, either a phosphorescent layer is applied to the outside or to the inside of the glass cover, or one of the two sides is provided with a fluorescent film, or another method for producing a real image is applied. The real image can then be projected further on a display screen (not shown) by means of a projection optical unit 46, which is schematically shown in FIG. 8, and made visible there in an enlarged form.

In a similar way as shown in FIG. 7, the display screen can be constructed outside the scanner system, as shown in FIG. 9. This figure shows essentially the same structure for generating the Bessel beams as FIG. 7. Solely the axicon angles of the axicons 4 and 5 are selected in such a way that the overlap region of the ring-shaped intensity distribution 23 is outside the planar glass cover 22.

The adaptation of the distances of the axicons 4 and 5 can result in the same situation. Bessel beams or specifically Bessel-like beams also form here inside the overlap volume of the ring-shaped intensity distribution, as simulated and shown in FIG. 2. The Bessel beams are then incident on a display screen 23, which is used to make the intensity distribution visible. In this structure as well, the torsion oscillations of the MEMS scanner cause the intensity distribution of the Bessel beams to pass over the display screen 23 in accordance with the reflection conditions. In this exemplary embodiment, in contrast to the embodiment shown in FIG. 7, the display screen 23 is then coated using the phosphorescent material or provided with the fluorescent film.

FIG. 10 shows an exemplary embodiment in which the vacuum capsule is produced without centrally-symmetrical geometry. The center of the still spherical glass dome 24 is no longer in the pivot point of the scanner mirror here. This means that the passage of the ring-shaped intensity distribution is no longer axially symmetrical to the glass dome 24.

FIG. 10 shows a sectional illustration in which the optical structure for generating Bessel beams is essentially the same as shown in FIG. 3. The center of the spherically-shaped glass dome 24 can be shifted relative to the plane of the MEMS component 9 in the x, y, or z direction here. In the same way as in the exemplary embodiment shown in FIG. 3, either a part of the inside or a part of the outside of the dome 24 is also equipped in the case shown in FIG. 10 with the optical properties which enable the generation of a real image in 25.

In FIG. 3, the ring-shaped intensity distribution goes symmetrically through the glass dome of the vacuum capsule. Therefore, the wavefronts experience the same phase shifts everywhere. This is also the case for planar glass covers, notwithstanding the angle which the cover has in relation to the beam. This is no longer the case in the situation shown in FIG. 10. In the beam path shown in the sectional illustration, the beams shown in the upper part have a different passage angle through the glass dome than those in the lower part. This means that the beams shown in the upper part experience a different phase shift. The intensity distribution of the Bessel beams therefore appears completely different than the distribution for the symmetrical case shown in FIG. 2. For reasons of the production technology for the spherical glass dome 24 described here, this is the most frequently occurring case. The center of the spherical glass dome and the pivot point coinciding is a desired, but unfortunately not always achievable special case.

FIG. 11 shows an embodiment of the glass capsule 26 of the MEMS scanner having an irregular geometry. The geometry shown here is representative for arbitrarily many irregular geometrical forms. Those geometrical forms are also to be subsumed among these which are not irregular in the mathematical meaning. Glass capsules in elliptical embodiment, in cylindrical embodiment, inter alia are to be counted among them here, for example.

The generation of the Bessel beams is carried out using the laser 1a and the beamforming optical unit 2 and also using the axicons 4 and 5. Similarly to the exemplary embodiment from FIG. 10, the irregular form of the vacuum capsule 26 has the result that the passage of the ring-shaped intensity distribution no longer takes place axially symmetrical to the glass dome 26. Since the overlap region 27 is also on the irregularly formed surface 26, the real images generated there have to be equalized in accordance with the surface form using image control algorithms.

FIG. 12 shows a possible embodiment of a device for the production of Bessel beams using glass-formed axicons 28, 29 made of an optically transparent, refractive material. A laser 1a having a laser beam 1 having a Gaussian characteristic is set using a beamforming optical unit 2 primarily with respect to its diameter and its divergence. It is subsequently incident on an axicon 28, which is manufactured from refractive material transparent in the optical range and is cut to size concavely conical on (at least) one side. The laser beam 1a thus receives a ring-shaped intensity distribution, which is incident at a suitable distance and at a suitable angle on the axicon 29. The axicon 29 also consists of a refractive material and has a convex conical form on both sides. The optical axes 6 of the axicons 28 and 29 and of the beamforming optical unit and the central axis of the laser beam 1a are collinear. The axicon angles of the axicons 28, 29 are set in such a way that the ring-shaped intensity distribution is collimated after passage through the axicon 29.

Similarly as in the embodiment of FIG. 3, the ring-shaped intensity distribution is incident on the MEMS mirror 8 within the MEMS component 9. The MEMS mirror 8 executes torsion oscillations along its oscillation axes, which result in the deflection of the ring-shaped intensity distribution. The pivot point of the MEMS mirror is ideally on the optical axis 6 of the optical components 2, 28, and 29. In the exemplary embodiment shown here, the MEMS component 9 having the MEMS mirror 8 is provided with a spherically shaped vacuum capsule 30. Both the axicon angles and also the respective distances of the components from one another are set so that the ring-shaped intensity distribution overlaps in the region 31 around the spherical glass dome and forms the Bessel beams described in FIG. 2.

As already mentioned with respect to FIG. 3, the ring-shaped intensity distribution which is induced by the axicons has a significant advantage in relation to the layout of the 2D (also 1D) MEMS scanner.

Because the MEMS mirror is only illuminated in its edge region, it is only necessary to design this region for the deflection of the ring-shaped intensity distribution. The mirror therefore also only has to reflect in a ring-shaped region.

A comparison of the geometry of a standard MEMS mirror with a MEMS mirror for a ring-shaped illumination is shown in FIG. 13. In FIG. 13a, a circular standard MEMS mirror 32 without the spring suspensions is shown by way of example. The MEMS mirror executes torsional oscillations around the axes 33 and 34. The ring-shaped intensity distribution is incident within the area 35 on the MEMS mirror, which is delimited by the dashed line. Outside this area 35, the MEMS mirror is not illuminated. For this reason, it is possible and advantageous to design the MEMS mirror 32 in adapted form having a mass-saving recess.

A MEMS mirror 36 in this adapted form is shown by way of example in FIG. 13b. The MEMS mirror 36 executes torsional oscillations around the two axes 37 and 38. The area 39 which is delimited by the dashed line indicates the region on the MEMS mirror 36 which is illuminated by the ring-shaped intensity distribution. Inside the area of the MEMS mirror 36 which is not illuminated, the MEMS mirror 36 has the recess 40. This has the result that the MEMS mirror 36 has a lower mass at equal outer radius than the MEMS mirror 32 in FIG. 13a. Due to the lower mass, the MEMS mirror 36 has a lower moment of inertia than the MEMS mirror 32 without recess. The MEMS mirror 36 therefore requires a lower drive force to maintain the two torsional oscillations around the axes 37 and 38 than the MEMS mirror 32 in FIG. 13b. Overall, the recess 40 has a positive effect on the mirror performance.

In FIG. 13c, a similar embodiment of the MEMS mirror is shown for the more general case that the ring-shaped intensity distribution has a greater angle of incidence relative to the surface normal of the MEMS mirror (10°-80°). For greater angles of incidence, the area illuminated by the ring-shaped intensity distribution has a pronounced elliptical shape.

The MEMS mirror 41 advantageously has an elliptical embodiment and oscillates around the torsion axes 42 and 43. Because of the angle of incidence of the ring-shaped intensity distribution on the MEMS mirror 41, the illumination area 44 delimited by the dashed line is accordingly elliptical.

The recess 45 is advantageously also accordingly embodied as elliptical. The recess 45 is embodied as elliptical notwithstanding the outer geometrical shape of the MEMS mirror 41.

High-resolution images, which can be further processed suitably, may be generated by scanning with reasonable expenditure by the described image generating device.

1. An image generating device having a radiation source for one or more output beams having Gaussian radiation characteristic, in particular a laser beam source,
having a device for generating Bessel-like beams from one or more output beams,
having a controllably drivable MEMS scanner,
wherein the Bessel-like beams are directed onto the MEMS scanner and are deliberately deflected by the MEMS scanner to generate an image,
and having at least one display body at least partially transmissive to the Bessel-like beams, onto which the Bessel-like beams are guided by the MEMS scanner.

2. The image generating device as claimed in claim 1,
characterized by a projection device, which projects the image from the display body by means of a projection optical unit on a projection surface.

3. The image generating device as claimed in claim 1, wherein the device for generating Bessel-like beams has at least one axicon.

4. The image generating device as claimed in claim 3, wherein at least one axicon is designed as a mirror or as a refractive element, in particular a lens.

5. The image generating device as claimed in claim 3, wherein the device for generating Bessel-like beams has at least two axicons aligned coaxially to one another.

6. The image generating device as claimed in claim 1, wherein the device for generating Bessel-like beams has an aperture having a ring gap, onto which the output beam or beams are directed, wherein in particular at least one converging lens is provided after the ring gap seen from the radiation source.

7. The image generating device as claimed in claim 1, wherein the MEMS scanner is designed as a 2D MEMS scanner having a mirror rotatable or pivotable around multiple axes.

8. The image generating device as claimed in claim 1, wherein a capsule wall of the MEMS scanner is designed as a display body, wherein the capsule wall for the image generation in particular has a planar section or a section in the form of a spherical cap, the sphere center point of which coincides with the point in which two pivot axes of a MEMS mirror intersect.

9. The image generating device as claimed in claim 1, wherein the display body is designed as a focusing screen or is coated using a phosphorescent or fluorescent substance, in particular a phosphorescent or fluorescent film.

10. The image generating device as claimed in claim 1, wherein the or at least one MEMS mirror has an in particular circular or elliptical recess.
